(19) United States
(12) Patent Application Publication
(10) Pub. No.: US 2020/0203962 A1
(43) Pub. Date: Jun. 25, 2020

(54) METHOD AND DEVICE FOR CONTROLLING RECHARGING AND DISCHARGING OF BATTERIES OF A SET OF BATTERIES

(71) Applicant: Orange, Paris (FR)

(72) Inventors: Didier Marquet, Châtillon Cedex (FR); Brian Francoise, Châtillon Cedex (FR)

(21) Appl. No.: 16/723,025

(22) Filed: Dec. 20, 2019

(30) Foreign Application Priority Data
Dec. 20, 2018 (FR) 1873524

(51) Int. Cl. H02J 7/00; H02J 7/35

(52) U.S. Cl. CPC H02J 7/0018; H02J 7/35; H02J 7/0071; H02J 7/0025

(57) ABSTRACT

Methods and control devices are described for controlling recharging and discharging a set of batteries, each of the batteries connected to an electrical circuit connecting a power supply source to a consuming device to form a recharging circuit connecting the battery to the power supply source, and a discharging circuit connecting the battery to the consuming device and performing a diode function to avoid a circulation current between the batteries. The method can include at least one of recharging of a first battery of the set, simultaneously with a resting of at least a second battery of the set, the recharging of the first battery being followed by resting of the first battery, or discharging of a first battery of the set, simultaneously with a resting of at least a second battery of the set, the discharging of the first battery being followed by the resting of the first battery.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Technical Field

The disclosed technology relates to the general field of batteries of rechargeable electric storage cells. It relates more particularly to electric power supply to electronic devices situated in zones with no reliable electrical network, in other words, with no electrical network which satisfies strict requirements of electrical current, voltage and/or supplied power availability and stability.

### Background

To supply consuming electronic devices in zones not covered by electrical networks, a first solution consists of using generator sets, for example Diesel engines producing electrical power.

However, the generator sets are generally oversized relative to the operating power of the consuming devices that they supply, which leads to fairly low efficiency and to premature wear of the generator set. By way of an example, the operating powers required to supply telecommunications equipment and air conditioning equipment are each of the order of 1 to 4 kW. In this case, the average charging rate of a generator set which supplies these two pieces of equipment is only comprised between 10 and 50%.

A second solution consists of associating a battery with a generator set to form a hybrid power supply system (HGB for “Hybrid Genset Battery”). Two phases are alternated: for a first phase, the generator set supplies the consuming devices and also charges the battery, then during a second phase, the generator set is set off and the battery is discharged to supply the consuming devices. The first and the second phase can each last a few hours. This solution allows increasing the lifetime of the generator set by reducing its operating time, the cost of its maintenance, and by making it operate at a higher charging rate (because it is supplying the battery in addition to the consuming devices), ideally at 75% to obtain a lower fuel consumption.

In the case of the availability of an unreliable electrical network, for example with availability reduced to a few hours per day, a third solution for supplying consuming electronic devices consists of associating a battery with the unreliable electrical network: the battery is recharged and is kept charged as long as the electrical network is available, while the consuming devices are simultaneously supplied by this electrical network, and when the electrical network is no longer available, the battery is discharged to feed the consuming devices with an autonomy of several hours.

The second and the third solution, both based on the use of a battery in alternation with another power supply source, have disadvantages linked to the longevity of the batteries, to their costs and/or to constraints on using these batteries.

As regards currently available batteries and their use:
the most widely used batteries are of the lead-acid type. Their longevity in charge and discharge cycles is limited, in particular with a high ambient temperature such as a temperature higher than 30° C. In Africa for example, the lifetime of a rechargeable lead battery performing up to ten charge/discharge cycles per week to 50% of its capacity is often only 2 to 4 years. However, a lead battery can include several branches connected in parallel at different charging states, which allows a defective branch to be replaced by another without risking cutting off the system.
builder information and tests on lithium batteries show that their lifetime can reach from 6 to 7 years in deep cycle operation, i.e. with charge and discharge cycle in which discharge continues until the battery reaches its low voltage cutoff, generally defined as 70 to 90% discharge. However, lithium batteries have an initial cost 3 to 4 times greater than lead batteries and are therefore still little used (a few percent of the market). Moreover, paralleling lithium batteries is rather complex if these batteries are not at the same state of charge, i.e. at the same voltage.
so-called high-temperature batteries such as liquid sodium batteries or nickel chloride batteries have good electrochemical efficiency, but their overall efficiency, with temperature held at approximately 300° C., is on the order of 50 to 75%. In addition, in the event of failure of the other power supply source (the generator set or the unreliable electrical network), the intervention period must not exceed the cooling time of the high-temperature battery, because a cooled battery can require up to several days to increase temperature slowly so as not to break the internal ceramics of the battery. Thus high-temperature batteries are used only with other reliable power supply sources and in zones that are rapidly accessible for maintenance.
REDOX or “flow” batteries such as vanadium salt oxidation-reduction flow batteries have the advantage of being able to increase capacity by increasing the size of an external liquid reservoir. But these batteries have modest efficiency in constant use due to electrical leakage between the series elements via the conducting saline fluids used and they demand a good deal of maintenance. For example, the zinc-bromine REDOX battery must be stopped once per week for its regeneration and its automatic internal cleaning. In addition, operation in alternation of REDOX batteries with another power supply source has not been proposed.

For this reason, even the second and third previously described solutions, which use a battery associated with another power supply source, are not satisfactory.

There exists a need for a solution allowing supplying electronic devices in a zone not having a reliable electrical network, and which does not have some of the disadvantages of the prior art.

### SUMMARY

The disclosed technology includes a method for controlling charging and discharging of batteries of a set of said batteries, each of these batteries being connected to an electrical circuit connecting a power supply source to a consuming device to form:
a controllable electrical circuit, called a recharging circuit, connecting the battery to the power supply source; and
a controllable electrical circuit, called a discharging circuit, connecting the battery to the consuming device and performing a diode function to avoid circulation current between the batteries, said method comprising at least:
recharging of a first battery of the set, simultaneously with a resting of at least one other battery of the set, called the second battery, the recharging of the first battery being followed by resting of the first battery; or
discharging of a first battery of the set, simultaneously with a resting of at least one other battery of the set, called the second battery, the discharging of the first battery being followed by resting of the first battery,

in said method:
said recharging of any of the batteries consists of controlling the closing of the electrical recharging circuit corresponding to this battery for recharging the battery by the power supply source;
said discharging of any of the batteries consists of controlling the opening of the electrical recharging circuit and controlling the closing of the electrical discharging circuit corresponding to this battery for discharging the battery for supplying the consuming device;
said resting of any of the batteries consists of controlling the opening of the electrical recharging and discharging circuits corresponding to this battery in order to rest it;

the consuming device being supplied either by the power supply source, or by the discharging of a battery.

As a corollary, the disclosed technology also includes a control device for controlling the charging and discharging of batteries of a set of said batteries, each of these batteries being intended to be connected to an electrical circuit connecting a power supply source to a consuming device to form a controllable electrical circuit, called a recharging circuit, connecting the battery to the power supply source, and a controllable electrical circuit, called a discharging circuit, connecting the battery to the consuming device and performing a diode function to avoid circulation current between the batteries, the control device including a coupling module configured to genrate at least:
a command for recharging a first battery of the set, simultaneously with the resting of at least one other battery of the set, called the second battery, the recharging of the first battery being followed by the resting of the first battery;
a command for discharging a first battery of the set, simultaneously with the resting of at least one other battery of the set, called the second battery, the discharging of the first battery being followed by the resting of the first battery;

The coupling module is configured to generate rechanging commands and discharging commands such as the consuming device is supplied by the power supply source or by a discharging of a battery;
said recharging of any one of the batteries consists of controlling the closing of the electrical recharging circuit corresponding to this battery for recharging the battery by the power supply source;
said discharging of any one of the batteries consists of controlling the opening of the electrical recharging circuit and controlling the closing of the electrical discharging circuit corresponding to this battery for discharging the battery to supply the consuming device;
said resting of any one of the batteries consists of controlling the opening of the electrical recharging and discharging circuits corresponding to this battery in order to rest it.

Thus, according to embodiments described herein, the consuming device is supplied without interruption, i.e. continuously, either by the power supply source, or by the discharging of a battery.

The features and advantages of the control method according to the certain embodiments presented hereafter apply in the same manner to the control device, and vice versa.

In conformity with the disclosed embodiments, it is said that recharging and resting, or discharging and resting, are simultaneous and carried out simultaneously if they begin at the same time and terminate at the same time.

The disclosed technology thus allows supplying the consuming device in a continuous manner (i.e. without cutoff), either from the power supply source or from at least one of the batteries in the set of batteries. Resting of the batteries is introduced without reducing the power supply to the consuming device.

Within the meaning of the disclosed technology, resting a battery is its disconnection from any power supply source and from any consuming device. During this phase, a state of charge of the battery remains constant.

Within the meaning of the disclosed technology, recharging a battery is a phase during which the battery is supplied electrically by the power supply source and stores electrical energy. During this phase, the state of charge of the battery increases.

If the electrical discharging circuit of a battery is closed, this discharging circuit will be short-circuited during recharging of this battery.

In one embodiment, recharging a battery also includes opening said electrical discharging circuit of this battery.

Within the meaning of the disclosed technology, discharging a battery is a phase during which the battery provides electrical energy, to supply the consuming device. During this phase, the state of charge of the battery decreases.

The recharging and discharging circuits of a battery could be controlled independently of each others.

The nominal values of capacity and of voltage of a battery are those defined by the builder of the battery in compliance with a standard.

Within the meaning of the disclosed technology, one cycle of a battery comprises at least one recharge and at least one discharge of this battery.

Within the meaning of the disclosed technology, each battery of the set can be connected to one or more power supply sources and to one or more consuming devices.

Within the meaning of the disclosed technology, a battery can comprise a single branch or more branches with the same voltage, operating in parallel and made up of blocks. For example, a battery can include two parallel 48V branches, each branch including four blocks of 12V each.

In particular, the disclosed technology allows extending the lifetime of the batteries due to the rest time separating the recharge and discharge phases and/or vice versa. In fact, the batteries of the set are recharged and discharged alternately.

Experimental tests have been able to demonstrate a reduction in ageing in terms of loss of capacity per cycle due to resting between recharge and discharge phases of lithium storage batteries, even when making them operate at 100% of the nominal capacity.

For example, at a temperatures between 35 and 45° C. and over 1000 recharge and discharge cycles, the resting of a battery between 15 and 30 minutes between the recharging and discharging phases and vice versa allows the ageing slope to be reduced from ten percentage points to a few percentage points. Under these conditions, the lifetime of the battery can reach more than ten years. The use of lithium batteries can then be favored relative to lead batteries, given that over such a long lifetime, there will be a return on the initial investment.

The batteries in the set can have different nominal capacities or the same nominal capacity.

The resting of one battery can allow reducing the temperature of the battery, which improves its lifetime, but also reduces the need to operate equipment for cooling the battery, such as an air conditioning unit. The disclosed technology therefore allows reducing energy consumption.

In one preferred embodiment, at least one battery in said set is of the lithium type. As mentioned previously, the lithium battery offers deep cycles, works between 80 and 100% of nominal capacity, and has a longer lifetime that other types of batteries. In addition, the extension of the lifetime of the battery due to the solution proposed by the disclosed technology allows having a return of investment on the initial cost of the lithium battery.

In one preferred embodiment, at least one battery of said set is of the lithium or nickel type (for example NiCd, NiZn or NiMH) accepting sufficient power during recharging and discharging so that a single battery of said set can, on the one hand, supply all the power required by the consuming device and, on the other hand, accept the maximum power of the power supply source.

The capacity of the set of batteries according to the described embodiments can be equal to the capacity of a single battery in conformity with a power supply solution of the prior art. The fact of having a set of at least two batteries does not result in an increase of the cost of batteries compared to the solutions of the prior art.

In one embodiment, the resting is not added systematically after each recharging and after each discharging. It is possible to rest a battery after each recharge of this battery for example, or after each discharge, or after a given number of cycles. The gain in terms of lifetime of a battery decreases as this number of cycles increases.

In one embodiment, the control method also comprises, for at least one battery in the set, a cyclic sequence including:
at least one recharging followed by resting; and
at least one discharging followed by resting.

The disclosed technology therefore allows lengthening the lifetime of this battery.

In one embodiment, the control method also comprises, alternately between at least two batteries of the set, a sequence including:
at least one recharging followed by resting; and
at least one discharging followed by resting;
   the durations of recharging, discharging and resting of this sequence being able to be different for each of the batteries.

The disclosed technology thus allows supplying the consuming device with one of the discharging batteries while lengthening the lifetime of each of the alternated batteries.

In one of embodiment, the control method also comprises a step of monitoring information representing an activity state of the power supply source. As long as the state of the power supply source is active, the recharging of the first battery is implemented until a predetermined state of charge, the consuming device being supplied by the power supply source. As long as the state of the power supply source is inactive, the discharging of the first battery is implemented until a predetermined state of charge

In one embodiment, the control method also includes a step of obtaining an information representing a state of charge of a battery of the set for determining the battery that is recharging or discharging.

The determination of the battery to which a recharge or a discharge is applied, is then based on precise information on the state of charge of each battery, which reduces the risk of selecting for discharge a battery which is not sufficiently charged to be able to supply the consuming device or selecting for recharge a battery already having a high state of charge, when another battery has a greater need of recharging.

The information representing a state of charge of a battery can be obtained for example by physical measurements, or by estimates such as calculations performed by machine learning algorithms.

In one embodiment, determining a battery to which a recharge or a discharge is applied is accomplished systematically in alternation between the different batteries of the set, based on a chronometer for example, or on a period of availability of the power supply source.

The diode function associated with a battery allows preventing a circulation current between this first battery and a second battery. Recall that such an inter-battery circulation current can occur when the batteries are not at the same state of charge, and when the recharging circuit or the discharging circuit of a first battery is closed simultaneously with the closing of the discharging circuit of a second battery. It can be noted that this inter-battery circulation current can be much higher than the discharging current of the batteries, and can therefore destroy them.

For example, consider a thin plate pure lead storage cell of 100 Ah (Ampere-hour) charged at 2.1 V of electromotive force, and having an internal resistance of 5 mOhms. When this storage cell discharges more than half of its discharging capacity for a rate of 3 hours (3 h) by providing a current of the order of 33 Amperes (A), it will have after discharging a voltage of 1.9V, and its internal resistance will have increased by a few mOhms, for example by 8 mOhms. Consider two 48V nominal batteries each comprising 24 previous storage cells in series. If these two batteries are connected in parallel, the inter-battery circulation current could reach 24×VoltageDifference/InternalResistance=24*(2.1−1.9 V)/(5+8 mOhms), namely 369 Amperes. Such an inter-battery current would be 10 times higher than the discharging and charging current (33 A) observed at 3 h rate. This example represents a case of common use for the HGB-type hybrid systems.

Due to the diode function, the disclosed technology allows preventing such a circulation current between the batteries. Thus, it protects the batteries and extends their lifetime.

In another embodiment, the control method also includes a step consisting of controlling the power supply source to make it in the active state or in the inactive state. In conformity with this embodiment, the information representing the activity state of the power supply source is supplied by this source control step.

The power supply source is therefore started only in the event of needing to recharge a battery. This mode therefore allows reducing energy consumption, particularly fuel consumption when the power supply source is a generator set. In addition, this mode allows controlling the efficiency of the power supply source, reducing its starting time and the risks of premature wear, and therefore lengthening the lifetime of the power supply source.

In one embodiment, a duration of activity and a duration of inactivity of the power supply source are determined in advance; in other words, these durations are predefined. For example, the durations of activity and of inactivity can be predetermined to have constant values. The control step can consist of activating or deactivating the power supply source alternately and according to the durations of activity and inactivity. This mode therefore allows simple and periodic control.

In another embodiment, the duration of activity and the duration of inactivity of the power supply source are determined depending on the at least one piece of information representing the state of charge of a battery.

This embodiment allows optimizing gains in terms of the lifetimes of the batteries and of the power supply source because it is based on information regarding states of charge of the batteries. This embodiment also allows guaranteeing the availability of power supply for the consuming device.

In one embodiment, the control device includes:
a monitoring module configured to monitor information representing an activity state of the power supply source;
the coupling module being configured to:
   as long as the state of the power supply source is active, controlling the electrical recharging and discharging circuits corresponding to the first battery and the electrical circuits corresponding to the second battery for recharging the first battery until a predetermined state of charge, (during operation, the consuming device is thus supplied from the power supply source); and
   as long as the state of the power supply source is inactive, controlling the electrical recharging and discharging circuits corresponding to the first battery and the electrical circuits corresponding to the second battery for discharging the first battery until a predetermined state of charge.

In one embodiment, the control device also includes a communication module configured to obtain at least one piece of information representing a state of charge of a battery, to determine a battery to be recharged or discharged.

In one embodiment, the control device also includes a control module configured to control the activity state of the power supply source, the monitoring module being configured to obtain, from the control module, the information representing the activity state of the power supply source.

In one embodiment, the electrical recharging and discharging circuits corresponding to a battery of the set are included in the control device, or in the same physical housing as the control device. In another embodiment, these electrical circuits are not part of the control device, but are controlled by the coupling module of the control device.

The disclosed technology also includes a control system for controlling recharging and discharging batteries of a set of said batteries, each of these batteries being connected to an electrical circuit connecting a power supply source to a consuming device to form a controllable electrical circuit, called a recharging circuit, connecting the battery to the power supply source and a controllable electrical circuit, called the discharging circuit, connecting the battery to the consuming device, the system including:
a control device, as previously described;
the power supply source; and
the consuming device.

In operation, the control device is such that the consuming device is supplied either by the power supply source, or by the discharging of a battery.

In one embodiment, the power supply source is an electrical generator, a generator set, a solar panel or a wind turbine. Several types of sources can then be considered.

In one embodiment, the consuming device is a wireless communication base station or a medical device.

Embodiments described herein can therefore be implemented for supplying without cutoff telecommunication equipment and therefore ensuring coverage of a communications network in zones which do not have a reliable electrical network available, such as rural zones or zones with difficult geographic, climatic or economic conditions.

Various embodiments can also be implemented for supplying in such zones without cutoff, i.e. without interruption, medical devices having requirements in terms of availability of power supply, necessitating for example permanent availability.

Various embodiments can also be implemented for supplying, in such zones, other devices with less demanding constraints.

The disclosed technology also includes a computer program on a storage medium, this program being capable of being implemented on a computer or in a control device, this program including suitable instructions for implementing a control method as described above.

This program can use any programming language and be in the form of a machine code, source code, object code or intermediate code between the source code and the object code, such as in a partially compiled form, or in any other desirable form.

In particular, this program can be executed by a microcontroller μC.

The disclosed technology also includes information or storage media readable by a computer, and including instructions of the computer program as mentioned above.

The information or storage media can be any entity or device capable of storing programs. For example, the media can include a storage means, such as a ROM, for example a CD ROM or a ROM of a microelectronic circuit, or even a magnetic storage means, such as a diskette (floppy disk) or a hard disk, or a flash memory.

On the other hand, the information or storage media can be transmissible media such as an electrical or optical signal, which can be routed via an electrical or optical cable, by radio link, by wireless optical link or by other means.

The program can in particular be uploaded on a network of the Internet type.

Alternatively, each information or storage medium can be an integrated circuit into which the program is incorporated, the circuit being adapted to execute or to be used in the execution of the control method.

### BRIEF DESCRIPTION OF THE DRAWINGS

Other features and advantages of the disclosed technology will be revealed from the description given below, with reference to the appended drawings which illustrate an embodiment of it free of any limiting character. In the figures:

FIG. 1 illustrates a control system for two batteries in conformity with one embodiment;

FIG. 2 is a flowchart showing steps of a control method in conformity with an embodiment;

FIG. 3 is a flowchart of a control method steps in conformity with the embodiment presented in FIG. 1;

FIG. 4 is a timetable showing the states of charge of batteries of different capacities controlled according to the control method, the steps of which are presented in FIG. 3;

FIG. 5 is a timetable showing states of charge of batteries having the same capacity and controlled according to a control method in conformity with an embodiment;

FIG. 6 is a timetable showing states of charge of three batteries controlled according to a control method in conformity with an embodiment;

FIG. 7 is a flowchart showing the steps of a control method for a set of n batteries of an HGB system in conformity with an embodiment;

FIG. 8 is a timetable showing states of charge of three batteries controlled according to a control method in conformity with an embodiment;

FIG. 9 is a timetable showing states of charge of four batteries controlled according to a control method in conformity with an embodiment;

FIG. 10 is a timetable showing states of charge of four batteries controlled according to a control method in conformity with another embodiment;

FIG. 11 illustrates a control system for two batteries in conformity with an embodiment in which the system includes two power supply sources;

FIG. 12 is a flowchart showing the steps of a control method in conformity with the embodiment presented in FIG. 11;

FIG. 13 illustrates the functional architecture of a control device according to an embodiment; and

FIG. 14 illustrates the material architecture of a control device according to one embodiment.

### DETAILED DESCRIPTION OF THE PREFERRED EMBODIMENT

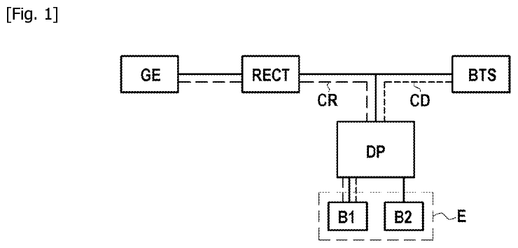

FIG. 1 illustrates an architecture of a control system for a set E of batteries B1 and B2. Each of these batteries B1 and B2 is connected to an electrical circuit connecting a power supply source GE to a consuming device BTS to form:
a controllable electrical recharging circuit connecting the battery to the power supply source GE; and
a controllable electrical discharging circuit connecting the battery to the consuming device BTS.

The system includes:
a control device DP;
the power supply source GE; and
the consuming device BTS.

In this embodiment, the power supply source is a generator set forming with the batteries B1 and B2 a hybrid power supply system of the HGB type. The two batteries B1 and B2 are of the lithium type. The consuming device BTS is a base station of a telecommunications network.

The control system is situated in a rural zone not having an available electrical network. Permanent electrical power supply to the consuming device BTS is required to ensure network coverage in this rural zone.

The control device DP implements a control method to control the recharging and the discharging of the batteries B1 and B2.

In this example, rectifiers RECT are placed at the output of the power source GE to convert an alternating current AC generated by the source GE into direct current DC.

Hereafter we designate, by “controlling recharging (respectively discharging and resting) a battery,” controlling the electrical recharging and discharging circuits corresponding to this battery for recharging it (respectively discharging it and resting it).

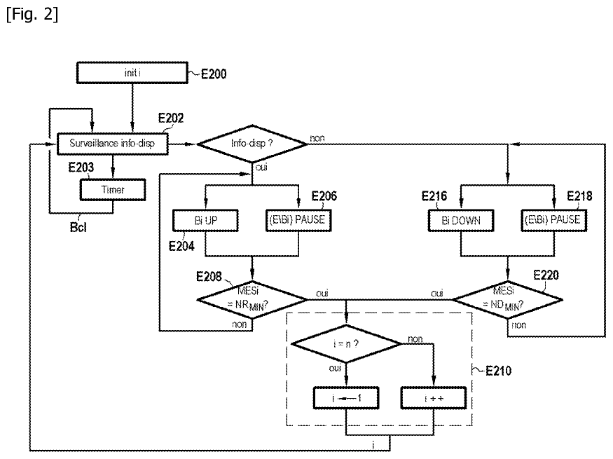

FIG. 2 is a flowchart showing generally the steps of a method for controlling a set E of batteries. The method is implemented by a control device.

In an embodiment described here, the control device DP controls a set of two batteries B1 and B2. The control device D and the set E are comprised in a control system as shown by FIG. 1. In this example, it is assumed that in the initial state, the two batteries B1 and B2 are rested and the state of charge of battery B1 is less than that of battery B2.

The method is initiated during a step E200, considering for example that the last battery Bi having been rested is the battery B1 and that the power supply source GE is initially in an active state. The index “I” is a positive integer comprised between 1 and the number of batteries in the set E, i.e. between 1 and 2 in this example, initialized during step E200 to the value 1. The battery B1 can be considered as the last battery having been rested, because its state of charge is less than that of battery B2.

During a step E202, the control device DP monitors information info-disp representing the activity state of the power supply source GE.

It is assumed that, initially, the state of the power supply source GE is active.

As long as the state of the power supply source is active:
the device DP controls the electrical circuits corresponding to the last rested battery Bi, namely in this example, at the first iteration, battery B1, for recharging E204 this battery B1 by the power supply source GE until a predetermined state of charge NRMIN; and
simultaneously with the recharging E204, the device DP controls the electrical circuits corresponding to the other battery of the set E, namely the battery B2 at the first iteration, for resting E206 this other battery B2; the consuming device BTS being supplied by the power supply source GE.

The monitoring step E202 is comprised in a loop Bcl which includes a step E203 of waiting, for a duration TIMER, between two successive iterations of the monitoring step E202.

If the duration TIMER expires before the state of charge of the battery B1 reaches the predetermined level NRMIN and the activity state of the power supply source GE is still active, the control device DP continues to control the recharging of battery B1 (E204) and the resting of battery B2 (E206).

During a step E208, the control device DP obtains information MESi indicating whether the state of charge of the recharging battery B1 (E204) has reached the predetermined level NRMIN.

If that is not the case (the state of charge of battery B1 has not reached the predetermined level NRMIN), step E208 is followed by recharging E204 of the battery B1 and the resting E206 of the battery B2.

If that is the case, the control device changes the value of the index i during a step E210 and again executes the monitoring step E202. In fact, the index i relates to the last battery having been rested, which in this exemplary embodiment is the battery B2.

Thus, in the next iteration of the loop of the monitoring step E202, if information info-disp confirms that the state of the power source GE is active, the control device DP controls the recharging of the battery B2 until the predetermined state of charge NRMIN and the resting E206 of the battery B1.

In this embodiment, the changing E210 of the index i is an incrementation by one unit if i is strictly smaller than the number n of batteries, or an assignment of the value 1 if i is equal to n.

Assuming that, during a later iteration of the monitoring step E202, the state of the power source GE becomes inactive.

As long as the state of the power source GE is inactive:
the device DP controls discharging E216 of the last battery Bi that was rested, being in this example battery B1, until a predetermined state of charge NDMIN, the consuming device BTS being supplied by this discharging battery, B1; and
simultaneously with the discharge E216, the device DP controls the resting E218 of the other battery of the set E, being in this example the battery B2.

If the control device DP obtains, during a step E220, information MESi indicating that the state of charge of the discharging battery B1 (E216) has reached the predetermined level NDMIN, the control device changes the value of the index i during step E210 and executes again the monitoring step E202.

The device DP changes alternately the battery to be recharged (E204) or to be discharged (E216), and consequently the battery to be rested (E206 or E218).

In the embodiment described above, the monitoring step E202 is repeated in a loop according to a countdown for a duration TIMER.

As a variant, the monitoring step E202 can be triggered upon reception of a message emitted by another device.

As a variant, the monitoring step E202 can be triggered following a change E210 in the value of the index i.

In one embodiment, if the states of charge of the two batteries B1 and B2 reach the predetermined state of charge NRMIN while the state of the power supply source GE is still active, the control device DP rests both batteries B1 and B2.

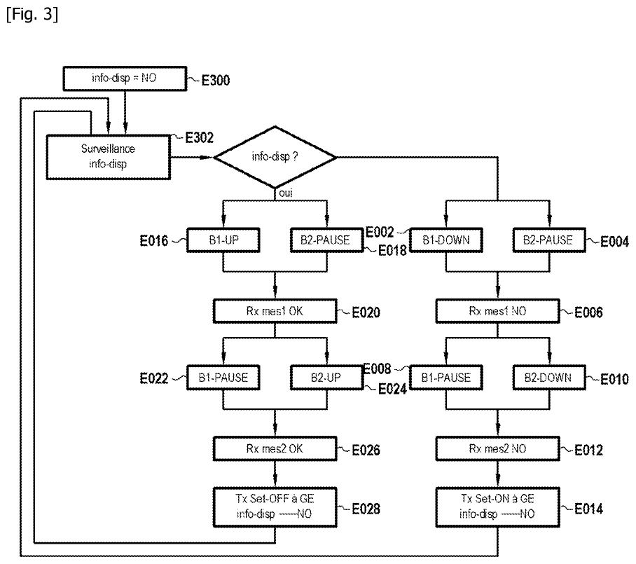

FIG. 3 is a flowchart representing the steps of a control method for a set E of two batteries B1 and B2. The method is implemented by the control device DP comprised in the control system described in reference to FIG. 1.

In this embodiment, the consuming device BTS is supplied either by the generator set GE or by one of the batteries B1 or B2.

In this embodiment, the control device DP controls the batteries B1 and B2 of the set E, but also the activity state of the generator set GE.

The method is initiated during a step E300. The generator set GE is initially shut down.

During a step E302, the control device DP obtains information info-disp representing the activity state of the power supply source GE, this information being supplied in this example by the control device itself. This information indicates that the source GE is in an inactive state.

It is assumed that initially, the batteries B1 and B2 are charged to a high state of charge, 100% for example.

In order to supply the consuming device BTS, the device DP controls the electrical circuits corresponding to the battery B1 to discharge it (E002) to a predetermined state of charge NDMIN, which is considered weak, 0% for example.

Simultaneously with the discharge E002, the device DP rests the battery B2 by controlling the opening of the recharging and discharging circuits corresponding to the battery B2 to rest it (E004).

During a step E006, the control device DP receives information mes1 representing the state of charge of battery B1, this information indicates that the state of charge of battery B1 has reached the state of charge NDMIN of 0%.

To maintain supply to the consuming device BTS, the device DP controls discharging E010 of the battery B2 until a predetermined state of charge NDMIN considered weak, 0% for example. The consuming device BTS is then supplied by the battery B2. The control device DP controls the resting E008 of the battery B1, simultaneous with the discharge E010.

During a step E012, the control device DP receives a second information mes2 representing the state of charge of the battery B2. This information indicates that the state of charge of the battery B2 has reached the predetermined state of charge NDMIN of 0%.

Both batteries B1 and B2 having predetermined states of charge considered to be weak, the control device DP controls, during a step E014, the starting (turning on) of the generator set GE. The consuming device BTS is then supplied directly by the power supply source GE.

Following step E014 and during a new iteration of the step E302, information info-disp then indicates that the activity state of the power supply source GE is active.

In this example, the last battery having been rested (E008) is battery B1. Consequently, the device DP controls recharging E016 of this battery B1 until a predetermined state of charge NRMIN, considered high, 100% for example, and simultaneously resting E018 of battery B2.

Note that at a given instant, the generator set GE is supplying both the consuming device BTS and one battery among B1 and B2.

During a step E020, the control device DP receives information mes1 representing the state of charge of battery B1, this information indicating that this battery B1 is charged to the level NRMIN, considered high, of 100%.

Upon reception of this information mes1, the device DP controls simultaneously the resting E022 of battery B1 and recharging E024 of battery B2 until a predetermined state of charge NRMIN, 100% for example.

During a step E026, the control device DP receives information mes2 representing the state of charge of battery B2, this information indicating that battery B2 is charged to the predetermined high level NRMIN of 100%.

As a result, the control device DP controls, during a step E028, the deactivation of the source GE.

The method repeats starting with step E302.

Note that each of the two batteries B1 and B2 is rested between each recharge and each discharge.

In this embodiment, the control device DP shuts down the source GE (E208) only when all the batteries B1 and B2 have states of charge considered to be high. As a variant, the control device DP can shut down the source GE as soon as the state of charge of one of the batteries B1 or B2 is considered strong.

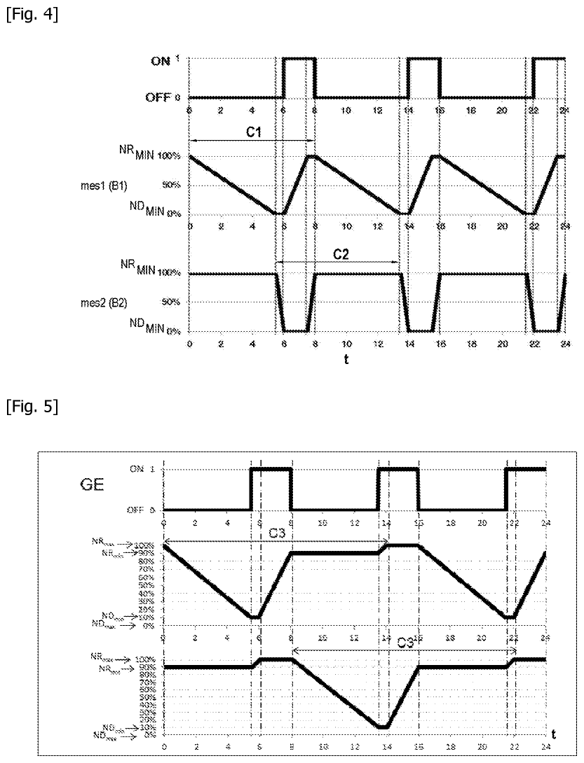

FIG. 4 is a timetable showing the different steps of the control method in conformity with the embodiment described with reference to FIG. 3. This timetable shows the evolution of the charge of the batteries B1 and B2 as a function of time, in hours.

Both batteries B1 and B2 have the same nominal voltage.

Battery B1 is of the lithium type with a nominal capacity slightly smaller than that of a conventional HGB system of the prior art, for example a capacity of 90%. Recall that an HGB power supply system of the prior art includes a single battery or several batteries connected in parallel and operating in parallel both in recharge and in discharge.

The second battery B2 covers only the duration of the resting of battery B1. The nominal capacity of battery B2 is less than that of battery B1.

In this example, battery B2 is also of the lithium type, but it can be of another type.

The discharging of battery B1 (E002) and the resting of battery B2 (E004) last, in FIG. 4, from instant 0 until five and a half hours later.

The resting of battery B1 (E008) and the discharging of battery B2 (E010) last from the five and a half hour point to the sixth hour. The two batteries being discharged, step E014 of activating the power source GE is implemented at the sixth hour.

The recharging of the battery B1 (E016) and the resting of the battery B2 (E018) last from the sixth hour until the seven and a half hour point, and they are followed by the resting of the battery B1 (E022) and the recharging of the battery B2 (E024) until the eighth hour, when step E028 is implemented to deactivate the generator set.

The loop is repeated starting at the eighth hour with a new implementation of steps E002 and E004.

In this embodiment, a cyclic sequence with a duration of 8 hours is applied alternately between the batteries B1 and B2, including discharging, followed by resting, then recharging, and finally another resting. The durations of discharging, of recharging and of resting are different for each of the batteries B1 and B2. The application of this cyclic sequence to the battery B2 is offset by five and a half hours relative to its application to battery B1.

In addition, a cyclic sequence C1 with a duration of 8 hours is applied to battery B1, comprising a discharge of five and a half hours, followed by a half hour of resting, followed by a recharge of one and a half hour, followed by another half-hour resting.

Another cyclic sequence C2, also with a duration of 8 hours, is applied to battery B2, including a half-hour discharge, followed by resting for one and a half hours, followed by a half-hour recharge, followed by another rest of five and a half hours.

Note that the flowchart described with reference to FIG. 2 is also in conformity with the embodiment described by the timetable of FIG. 4, the index i being initialized (E200) to the value 1, the information info-disp being initially negative and step E202 of monitoring the activity state of the source being re-implemented after each execution of the step E210 of modifying the index i, without taking into account a loop Bcl.

FIG. 5 is a timetable showing the different steps of the control process conforming to another embodiment.

This timetable shows the evolution of the states of charge of batteries B1 and B2 as a function of time, in hours.

The embodiment described here is similar to the embodiment described with reference to FIGS. 3 and 4, the two batteries B1 and B2 still having the same nominal voltage, but, in this embodiment, the batteries B1 and B2 also have the same nominal capacity. The sum of the capacities of batteries B1 and B2 can correspond approximately to the installed capacity of an HGB system of the prior art.

In this example, it is assumed that the state of the power supply source GE is initially inactive and that the states of charge of the two batteries B1 and B2 are at a level NRMIN of 90%, this initial level NRMIN being lower than a maximum state of charge NRMAX of 100%.

In this embodiment, unlike the embodiment described with reference to FIGS. 3 and 4, as soon as a single battery is discharged until a predetermined state of charge NDMIN considered to be weak, the control device DP controls the starting of the power supply source GE.

In this example, the state of charge considered weak NDMIN is non-zero, 10% for example. As a result, at a given instant, at least one of the two batteries has a non-zero state of charge, which allows guaranteeing supply to the consuming device BTS, assuming that the consuming device could not be supplied by the source GE due to a breakdown of the source GE for example, or a cutoff between the source GE and the consuming device BTS.

Compared to the embodiment described with reference to FIGS. 3 and 4, a tolerance is added to an intervention time for maintenance, for repairing the source GE of for connecting the source GE to the consuming device BTS for example. This tolerance corresponds to the discharge time of a battery to a zero state of charge NDMAX.

The fact that the initial state of charge NRMIN is less than the level NRMAX allows maximizing the efficiency of the source GE when recharging batteries from this state of charge NRMIN of 90% to the level NRMAX of 100% while the source GE supplies the consuming device BTS simultaneously with the resting of the other battery having a weak state of charge NDMIN of 10%. As illustrated in FIG. 5, this case occurs from the five-and-a-half-hour point to the sixth hour, from the thirteen and a half hour point to the fourteenth hour, and from the twenty-one and a half hour point to the twenty-second hour. The evolution of the timetable of FIG. 5 is explained hereafter.

Initially, the state of the power supply source GE is inactive.

From instant 0 until the five and a half hour point, the control device DP controls discharging of the battery B1 until a predetermined state of charge NDMIN, by way of an example 10%, and the resting of battery B2.

At the end of these steps (at the five and a half hour point), the device DP receives information mes1 indicating that the state of charge of battery B1 has reached the predetermined state of charge NDMIN of 10%. The control device DP then controls the starting of the power supply source GE, in a similar manner to step E014 described with reference to FIG. 3.

From the five and a half hour point to the sixth hour, the control device DP controls the resting of the battery B1 and the recharging of battery B2 from its state of charge NRMIN of 90% until a predetermined state of charge NRMAX of 100%. The efficiency of the source GE is maximized because the source GE supplies the battery B2 in addition to the consuming device BTS.

At the sixth hour, the control device DP receives information mes2 indicating that the battery B2 is charged to 100% level; it therefore controls the resting of this battery B2 and the recharging of battery B1 until a predetermined state of charge of 90%.

At the end of the eighth hour, the control device DP receives information mes1 indicating that the battery B1 is charged to the 90% state of charge. The control device DP then controls the shutdown of the power supply source GE in a similar manner to the step E028 described with reference to FIG. 3.

From the eighth hour to the thirteen and a half hour point, the control device DP control the discharging of the battery B2, to supply the consuming device BTS, from its current state of charge of 100% to the predetermined state of charge NDMIN of 10%. Simultaneously, the device DP controls the resting of battery B1.

At the thirteen and a half hour point, the control device DP receives information mes2 indicating that the battery B2 is discharged to the level NDMIN of 10%; it therefore controls the resting of this battery B2, the starting of the power source GE and the recharging of battery B1 from its current state of charge of 90% until a predetermined state of charge NRMAX of 100%.

At the fourteenth hour, the control device DP receives information mes1 indicating that the state of charge of battery B1 has reached the predetermined level NRMAX of 100%; the device then controls the resting of battery B1 and the recharging of battery B2 to the predetermined state of charge NRMIN of 90%.

At the sixteenth hour, the control device DP receives information mes2 indicating that the state of charge of the battery B2 has reached the predetermined level NRMIN of 90%; the device then controls the resting of this battery B2, the shutdown of the source GE and the discharging of the battery B1, to supply the consuming device BTS, until the predetermined state of charge NDMIN of 10%.

At the sixteen hour and a quarter point, the situation of the control system is similar to its initial situation at the instant 0: the state of the source GE is inactive and the states of charge of the two batteries B1 and B2 are 90%. The steps already described recur.

A same cyclic sequence C3 with a duration of 16 hours is applied alternately between the batteries B1 and B2. This sequence C3 comprises a discharge to the level NDMIN, followed with resting, then a first recharging to the level NRMIN followed by another resting, then a second recharging to the level NRMAX followed by another resting.

In the embodiment described here, the durations of discharging of the first and second rechargings and of the resting comprised in the sequence C3 are identical for both batteries B1 and B2. The two batteries B1 and B2 having the same capacity, the evolution of their states of charge is identical but with a time offset, of 8 hours in this example.

In this embodiment, as each battery B1 and B2 has half the capacity of a battery of an HGB system of the prior art, the source GE is started twice as often, but its operating time is the same. According to data of generator set manufacturers, up to ten starts per day do not reduce the lifetime of a generator set GE and of its starter.

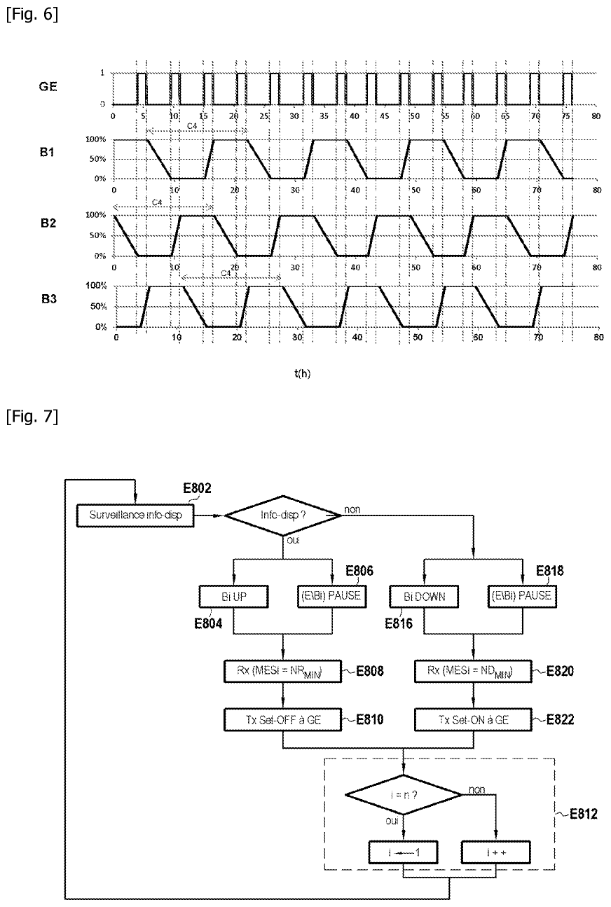

FIG. 6 is a timetable of the different steps of a control method conforming to an embodiment. In this embodiment, the set E includes three batteries, B1, B2 and B3. The control device DP controls the three batteries B1, B2 and B3, as well as the power supply source GE (generator set).

The control device DP controls, at a given instant, the recharging or the discharging of one battery of the set E and the resting of the two other batteries of the set E.

In this embodiment, it is assumed that the three batteries B1, B2 and B3 all have the same nominal voltage and the same nominal capacity, for example a nominal voltage of 48V and a nominal capacity of 300 Ah. The operating voltage of the battery can for example vary from 44V to 56V during operation.

Assuming that the nominal capacity of each of them is equal to one-third of the nominal capacity of a battery of an HGB system of the prior art, for example 100 Ah, the recharging and discharging times of each of the batteries B1, B2 and B3 are then shorter than those of the battery of the prior art, but the resting of the batteries B1, B2 and B3 allows their lifetimes to be extended.

In this embodiment, it is assumed that initially, the source GE is inactive, that the batteries B1 and B2 are charged to a level of 100% and that the state of charge of the battery B3 is 0%.

At instant 0, the control device controls the discharging of battery B2 to supply the consuming device BTS and the resting of the other batteries B1 and B3.

At the fourth hour, the control device DP receives information mes2 indicating that the state of charge of battery B2 is 0%. Two batteries (B2 and B3) are discharged; the control device DP then controls the starting of the source GE to supply the consuming device BTS and charge the battery B3 which had been resting.

At the five and a half hour point, the control device DP receives information mes3 indicating that the state of charge of battery B3 is 100%. Two batteries (B1 and B3) are charged; the control device DP then controls the shutdown of the source GE, the discharging of the battery B1 which had been resting, and the resting of the other batteries B2 and B3.

The situation at the five and a half hour point is similar to the initial situation: the state of the power source GE is inactive, two batteries have a state of charge of 100% and the third battery has a state of charge of 0%. The following steps presented on the timetable of FIG. 6 are not described because these steps are similar to the preceding steps (from the instant 0 to the five and a half hour point) already described.

A same cyclic sequence C4 is applied to each of the batteries B1, B2 and B3. This sequence C4 includes a discharge to a state of charge of 0%, followed by resting, then recharging to a state of charge of 100% followed by another rest.

In addition, this cyclic sequence C4 is applied alternately to the battery B2, then to the battery B1, then to the battery B3. In the embodiment described here, the durations of discharging, of recharging and of resting are identical for all the batteries B1, B2 and B3.

FIG. 7 is a flowchart recapitulating the steps of a control method of a set E of batteries in conformity with an embodiment, similar to the embodiment described with reference to FIG. 6, in which the set E of batteries comprises a number n of batteries, where n is an integer greater than or equal to 2.

During a step E802, the control device DP monitors the activity state of the power supply source GE.

As long as the state of the source GE is active, the control device controls, during two simultaneous steps E804 and E806, recharging of a battery Bi of the set E until a predetermined state of charge NRMIN considered to be strong, and the resting of the other batteries of the set E, i being an integer comprised between 1 and n and initialized until a predetermined value. In the embodiment described with reference to FIG. 6, i is initialized to the value 2.

During a step E808, the control device DP receives information MESi indicating that the state of charge of battery Bi has reached the level NRMIN considered to be high. Thus, the control device DP controls the shutdown of the source GE during a step E810.

Following the shutdown (E810) of the source GE, the control device DP modifies, during a step E812, the integer i for changing at each iteration the battery relating to the recharging step (E804) and thus the batteries relating to the resting step (E806). If the integer i is equal to the number of batteries n, then it is reinitialized to 1, otherwise it is incremented by one unit.

As long as the state of the source GE is inactive, the control device DP controls, during two simultaneous steps E816 and E818, the discharging of the battery Bi of the set E until a predetermined state of charge NDMIN considered to be low (weak) and the resting of the other batteries of the set E.

During a step E820, the control device DP receives information MESi indicating that the state of charge of the battery Bi has reached the level NDMIN considered to be weak. Thus, the control device DP controls the starting of the source GE during a step E822.

Following the starting (E822) of the source GE, the control device modifies, during a step E812, the integer i to change the battery to be discharged (E816) and the batteries to be rested (E818). If the integer i is equal to the number of batteries n, then it is reinitialized to 1, otherwise it is incremented by one unit.

After each modification (E812) of the integer i, the monitoring step E802 is reimplemented.

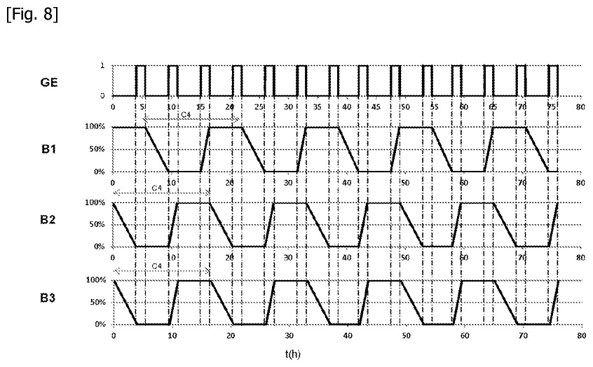

FIG. 8 is a timetable representing the different steps of a control method in conformity with an embodiment, which differs from the embodiment described with reference to FIGS. 6 and 7 in that the nominal capacity of each of the batteries B2 and B3 is equal to half that of the battery B1. In this embodiment, the batteries B2 and B3 are recharged, discharged and rested simultaneously.

The cyclic sequence C4 described with reference to FIG. 6 is applied to each of the batteries B1, B2 and B3. In addition, the sequence C4 is applied alternately between the battery B1 on the one hand, and the batteries B2 and B3 simultaneously, on the other hand.

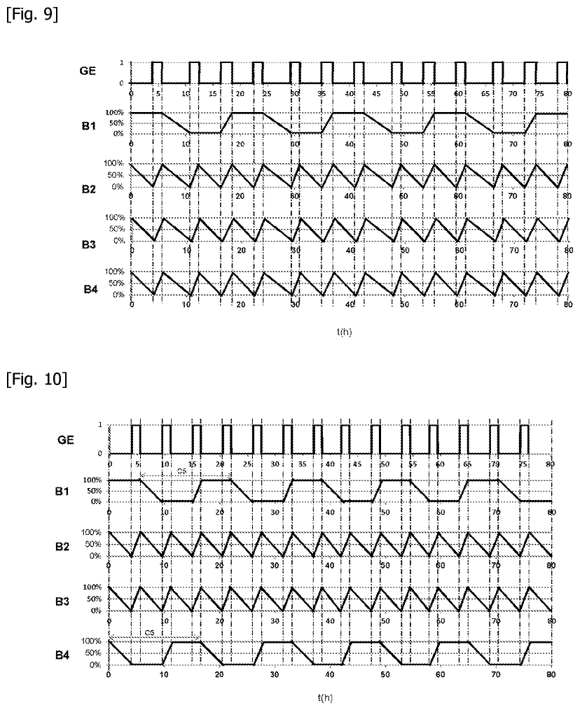

FIG. 9 is a timetable showing the different steps of a control method conforming to an embodiment, in which the set of batteries E includes 4 batteries, B1 to B4, all having the same nominal capacity.

In the embodiment described here, the control device DP controls the resting of the battery B1 after each recharge and after each discharge of this battery B1. However, the other batteries of the set E have simultaneous recharging and discharging cycles, with no resting. The recharging of battery B1 is simultaneous with the recharging of the other batteries, to increase the efficiency of the source GE. The discharging of the battery B1 is also simultaneous with the discharging of the other batteries.

FIG. 10 is a timetable showing the different steps of a control method in conformity with another embodiment, in which the set of batteries E also includes 4 batteries B1 to B4 all having the same nominal capacity.

This embodiment differs from the embodiment described with reference to FIG. 9, in that the control device DP controls the resting of each of the two batteries B1 and B4 of the set E after each recharging and each discharging of the battery in question.

A cyclic sequence C5 including a discharge followed by resting and a recharge followed by resting is applied alternately between the batteries B1 and B4.

Compared to the embodiment describe with reference to FIG. 9, the embodiment illustrated by FIG. 10 allows the lifetime of battery B4 to be lengthened, in addition to that of battery B1, while maintaining acceptable efficiency of the source GE despite the reduction of charge (3 batteries at a time).

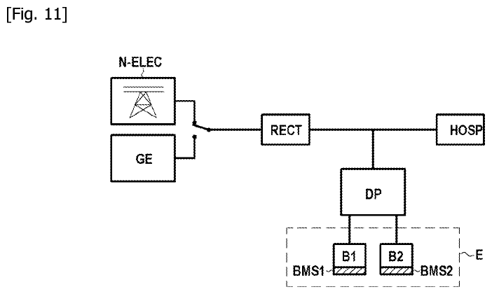

FIG. 11 illustrates an architecture of a control system of a set E of batteries B1 and B2, in conformity with an embodiment. This system includes two power supply sources: an unreliable electrical network N_ELEC and a generator set GE, the control device DP in conformity with an embodiment and a consuming device HOSP.

In this embodiment, the consuming device HOSP is an electronic medical device requiring a permanent availability of electrical current. The system shown in FIG. 11 is situated in a rural zone not having a reliable electrical network available.

In this embodiment, the control device DP controls a set of two batteries, B1 and B2, as well as the source GE, but does not control the activity state of the source N_ELEC.

In this embodiment, each of the batteries B1 and B2 includes an electronic management entity associated with the battery for its management, and called a BMS (Battery Management System).

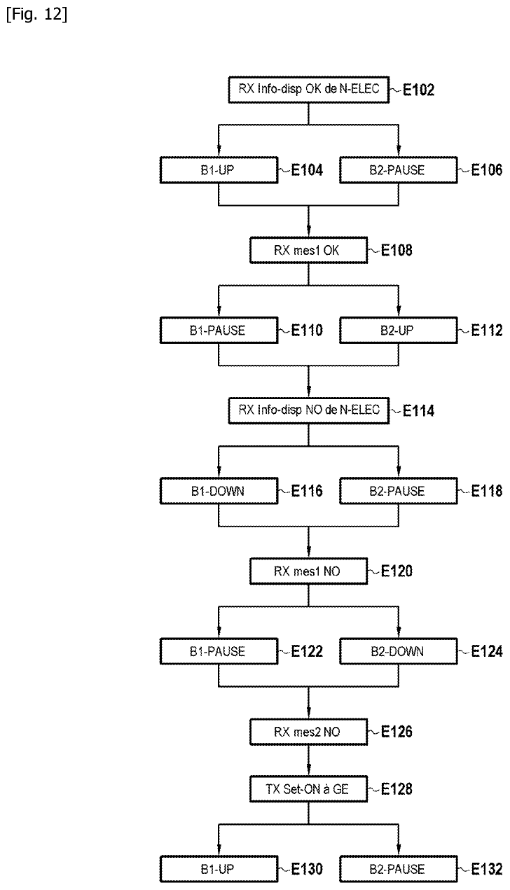

FIG. 12 is a flowchart showing the steps of a control method of a set E of two batteries, B1 and B2, in conformity with an embodiment. The method is implemented by the control device DP and comprised in the control system described in FIG. 11.

It is assumed that initially, the states of charge of the two batteries B1 and B2 are lower than a state of charge of 100%. The generator set GE is inactive.

During a step E102, the control device DP obtains information info-disp representing the activity state of the electrical network N_ELEC. This information indicates that the source N_ELEC is in the active state.

In this embodiment, the information info-disp on the activity state of the source N_ELEC is received from an alarm device. As a variant, the information info-disp is constantly monitored periodically by the control device DP, for example every 2 seconds.

As long as the source N_ELEC is available, the device DP controls the recharging of batteries B1 and B2. The consuming device HOSP is supplied directly by the source N_ELEC.

During a step E104, the device DP controls the recharging of battery B1 to the predetermined state of charge, 100% for example. Simultaneously, during a step E106, the device DP rests the battery B2.

During a step E108, the control device DP receives information mes1 representing the state of charge of battery B1, indicating that the state of charge of the battery B1 is 100%. The device DP then begins recharging the second battery B2.

During two simultaneous steps E110 and E112, the control device DP controls the resting of battery B1 and the recharging of battery B2 to the predetermined state of charge, 100% for example.

As the activity state of the source N_ELEC is being monitored, during a step E114, the control device DP obtains info-disp indicating that the state of the source N_ELEC has become inactive, even before the state of charge of the battery B2 has reached the predetermined level of 100%.

Consequently, to maintain the power supply of the consuming device HOSP, the control device DP controls the discharging of the battery B1 during a step E116 until a predetermined state of charge, 0% for example, and rests the battery B2 during a step E118 simultaneous with the step E116. The device DP selects for discharge the last battery to have been rested, namely the battery B1.

During a step E120, the control device DP receives information mes1 indicating that the state of charge of the battery B1 has reached the level of 0%.

The control device DP then controls supply to the consuming device HOSP by the battery B2. During two simultaneous steps E122 and E124, the control device DP controls the resting of the battery B1 and the discharging of the battery B2 until a predetermined state of charge, 0% for example.

During a second step E126, the control device DP receives information mes2 indicating that the state of charge of the battery B2 has reached the level of 0%.

The states of charge of the two batteries B1 and B2 having the predetermined level of 0% considered to be weak, the control device DP controls, during a step E128, the starting of the generator set GE to supply the consuming device HOSP and to recharge the batteries B1 and B2 alternately.

The battery B1 being the last to have been rested (E122), during a step E130, the device DP controls the recharging of the battery B1, and simultaneously, during a step E132, the resting of the battery B2.

### Other Embodiments

The embodiments already described can have different variants, for example in the selection of the states of charge which trigger recharging or discharging of a battery.

In one embodiment, the power supply source is an unreliable electrical network N_ELEC, which can have several cutoffs or supply electrical current or voltage with an unstable value.

In one embodiment, the power supply source is a generator SOL of electrical energy from solar energy.

In one embodiment, the power supply source is a generator WND of electrical energy from wind energy.

In one embodiment, the control system includes several power supply sources, of the same type or of different types.

In one embodiment, the control system includes at least two power supply sources of which one is a Stirling type generator. This type of generator can cover the operating power, i.e. supply the consuming device BTS, but not the recharging of the batteries.

The consuming device can be a device other than a base station BTS or a medical device HOSP. The consuming device is an electronic device which requires being supplied with electrical power with a minimum threshold of availability and/or a minimum threshold of stability in the level of intensity of the current, the voltage or the electrical power supplied to it.

In one embodiment, the control system includes several consuming devices.

In one embodiment, at least one of the batteries B1 and B2 controlled by the control device is of the lead or nickel type, or a high-temperature battery.

The batteries B1 and B2 of the set E of batteries are not necessarily of the same technology.

In one embodiment, the data mes1, mes2, mes3 representing the states of charge of the batteries of the set E are based on measurements of current or of voltage at the batteries.

In one embodiment, the data mes1, mes2, mes3 representing the states of charge in the batteries of the set E are based on estimates, using for example machine learning algorithms.

In one embodiment, the data mes1, mes2, mes3 representing the states of charge of the batteries are based on countdown timer TIMER. For example, it can be estimated that battery B1, the state of charge of which is presented in FIG. 4, is discharged over five and a half hours, and charges in one and a half hours.

### Description of a Control Device

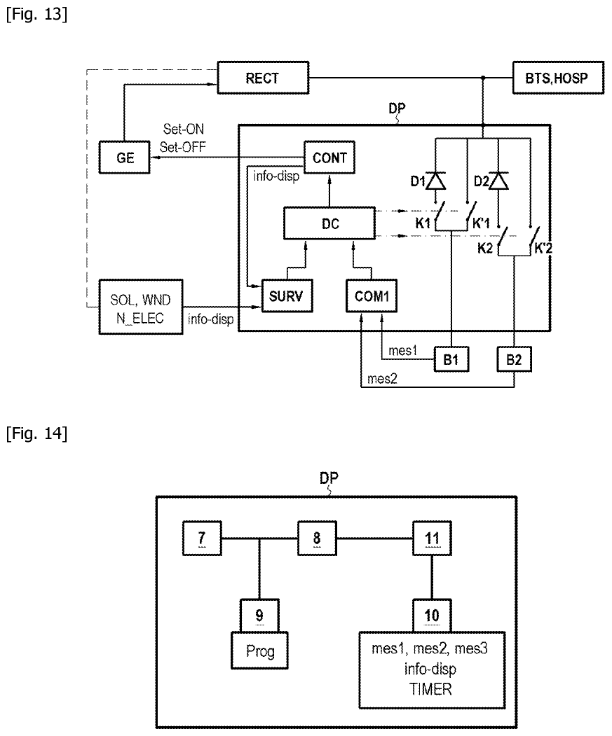

FIG. 13 shows a functional architecture of a device DP, conforming to an embodiment, as well as two power supply sources of different types: a first source GE of the generator set type, and a second source of the solar panel SOL, wind turbine WND or electrical network N_ELEC type.

The control device DP controls a set of two batteries B1 and B2, each of which can be connected to a power supply source and to a consuming device.

The control device DP includes:
a monitoring module SURV;
a coupling module DC;
connection means K1, K′1 (and K2, K′2) and a diode function D1 (and D2) forming the electrical recharging and discharging circuits of the battery B1 (and of B2), connecting this battery to one source among the sources N-ELEC, GE, SOL or WND, and to the consuming device;
a communication module COM; and
a control module CONT.

The monitoring module SURV is configured to monitor the information info-disp, each representing an activity state of a power supply source GE, SOL, WND or N_ELEC. This information can be obtained by receiving a message from the source in question or by reading from a memory.

In a particular embodiment, when the activity state of a source GE is controlled by the control device DP, this information info-disp is transmitted from the control module CONT to the monitoring module SURV.

The connection means K1, K′1 relating to a battery B1 are configured to ensure an electrical connection between the battery B1 and a power supply source N-ELEC, GE, SOL or WND for recharging the battery, or ensuring an electrical connection between the battery B1 and a consuming device for discharging the battery, or disconnect the battery B1 electrically from any power supply source and from any consuming device, to rest the battery.

In fact, two parallel circuits relate to each battery. For the battery B1 for example, the circuit including the means K1 and D1 in series, called a discharging circuit CD, allows passage of an electrical current for discharging the battery B1, while the circuit including the means K′1, called the recharging circuit CR, allows the passage of an electrical current for recharging the battery B1. During discharging phases, the discharge can be optimized by closing K′1 to avoid Joule losses in the diode.

In this embodiment, the connection means K1, K′1, K2 and K′2 are power switches. These switches can be electromechanical such as a relay, or electronic such as an MOS transistor.

The diode functions D1 and D2 can be passive diodes or controlled switches, for example a transistor controlled by an electronic circuit performing the same function as a passive diode.

When the switch K1 (respectively K2) is closed, the diode D1 (respectively D2) allows the instantaneous discharging of the battery B1 (respectively B2), and therefore obtaining uninterrupted supply when the power supply sources N-ELEC, GE, SOL or WND are no longer supplying current.

The closure of the switch K′1 (respectively K′2) allows recharging the battery B1 (respectively B2), but also during discharging phases to eliminate bypassing the Joule losses and the voltage drop in the diode function D1 (respectively D2) due to the threshold voltage of the diode function D1 (respectively D2).

The opening of the pair K1 and K1′ (respectively K2 and K2′) allows resting the battery B1 (respectively B2) and stopping any discharge below a critical voltage threshold for electrochemistry, below which there is a risk of irreversibility of the reactions in the elements, particularly by dendrite metallization and internal short circuit with heading and initiation of an oxidation reaction or uncontrollable combustion.

The coupling module DC is configured for:
as long as the state of a power supply source is active,
   controlling the connection means K1, K′1 of a battery B1 to close its recharging circuit CR and possibly opening its discharging circuit CD so as to recharge it with a power supply source N-ELEC, GE, SOL, or WND until a predetermined state of charge, if the electrical discharging circuit CD of the battery B1 is closed, this circuit CD will be short circuited during the recharging of this battery B1; and
   controlling the connection means K2, K′2 of the other battery B2 for opening its recharging and discharging circuits CR and CD in order to rest it; the consuming device being supplied by the power supply source N-ELEC, GE, SOL or WND;
as long as the state of all the power supply sources is inactive,
   controlling the connection means K1, K′1 of a battery B1 to open its recharging circuit and close its discharging circuit CD in order to discharge it until a predetermined state of charge and supply the consuming device from this discharging battery B1; and
   controlling the connection means K2, K′2 of the other battery B2 to open its recharging and discharging circuits CR and CD in order to rest it.

The recharging commands and discharging commands are such as the consuming device BTS, HOSP is supplied without cutoff either by the power supply source N-ELEC, GE, SOL, WND, or by a discharging of one of the batteries B1 and B2.

By way of an example, according to the embodiment described with reference to FIG. 5, at the instant 0, the coupling module DC controls closing the contactors K1 and K′1 and opening K2 and K′2. The battery B1 is discharged via the circuit including the switch K′1 without losses in the diode D1. The battery B2 is rested.

At the five and a half hour point, the battery B1 is discharged, the coupling module DC commands opening K′1, then the control module CONT controls starting the source GE. As soon as the source GE is started, the coupling module DC controls closing K′2; there is no current circulating between the batteries B1 and B2 because the switch K′1 is open. Then the coupling module DC controls opening K1, then closing K2. In this manner, the battery B2 is recharging and the battery B1 is resting.

At the sixth hour, the coupling module DC controls opening K′2, closing K′1, then opening K2.

At the eighth hour, the coupling module DC controls opening K′1 then closing K′2 and K2.

In the embodiment presented in FIG. 13, the connection means K1, K′1, K2, K′2, D1 and D2 are comprised in the control device DP. In another embodiment, these means are comprised in another device or another housing than the control device DP, but are controlled by the coupling module DC of the control device DP.

The recharging and discharging circuits CR and CD of a battery may be commanded independently of each others. The independence of recharging and discharging circuits allow introducing a certain redundancy. For example, the discharging of the battery B1 may occur by closing the switch K1, or by opening the switch K′1.

The control module CONT is configured to control the activity state of a power supply source, for example of the generator set type GE.

The communication module COM is configured to obtain at least one piece of information mes1 (resp. mes2) representing a state of charge of a battery B1 (resp. B2), for determining, depending on this information mes1 (or mes2) which battery among B1 and B2 is to be recharged or discharged.

The state of charge SoC of a battery can be expressed as a percentage relative to the available charge Q in the battery and the maximum capacity Cmax of this battery.

The charge Q and the state of charge SoC can be determined based on the voltage of the battery, if it reflects the state of charge.

The voltage is high at the conclusion of charging, for example greater than 3.45 V×k for lithium iron phosphate batteries, k being the number of series elements constituting the battery.

The voltage is low at the conclusion of discharging, for example lower than 3 V×k for these types of batteries.

For certain battery technologies, the voltage is not a sufficiently accurate indicator for intermediate states of charge and this measurement can be completed by a counter cumulating the charge Q at a given instant, this charge Q being assumed to be contained in the battery and bounded between 0 and the maximum capacity value Cmax.

The calculation of the charge Q uses at least measurements of current and of time, or even other measurements such as temperature and other information saved in memory such as reference data of the builder or historical data acquired during the use of the battery.

In one embodiment, the charge Q at an instant t+dt is expressed by:

Q(t+dt)=Q(t)+r·I·dt; where
I is the intensity of the recharging current (positive by convention) or of the discharging current (negative by convention) in the battery measured by means known to the prior art in the electronic field, such as the voltage on a shunt or a Hall effect sensor, and used by the control unit;
dt is an interval of measuring time with a current assumed to be constant or well smoothed on this interval by simple averaging or by calculation of the effective value, using for example a calculation method of the RMS (Root Mean Square) type;
r is the estimated efficiency; this efficiency r can have a constant value, for example 95%, or be variable; this efficiency r can depend on numerous parameters, such as:
   a state of the battery during discharging or charging, depending on the direction of current in the battery;
   a state of charge, for example the charging efficiency can collapse at the conclusion of charging;
   a temperature of the battery, for example lower efficiency when cold;
   a charging or discharging rate, for example a ratio between the current and the nominal capacity Cnom such as I=Cnom/3 and the efficiency is lower at a stronger rate;
   a state of health of the battery described by the residual performance in capacity and power or internal resistance.

The state of health is affected by the age of the battery, also called calendar ageing, the cycling history, the temperature, the time spent at different depths of discharge, the charging current, possible abuses undergone (overcharging, undercharging, short-circuit), poor maintenance, etc.

The state of charge can be expressed by:

Q=Cmax·max(min(0%,Q(t+dt)),100%)
where Cmax is for example 90% of the nominal capacity Cnom defined at an exchange current rate and a given temperature between the end of recharging and the end of discharging defined by the manufacturer, for example 100 Ah at 25° C. after a recharge of a battery to 30 amperes until 3.55V×k plus one hour at this constant voltage and down to 2.85V×k in discharging at 30 A.

In one embodiment, for better accuracy in calculation, the maximum value is corrected, for example depending on the nominal capacity of the battery, or depending on the state of health, or on the temperature.

In one embodiment, the measurements of state of charge of a battery can be acquired previously by a BMS entity associated with this battery.

In one embodiment, the information mes1 or mes2 are recovered via a communication link, for example a link of the analog, Modbus, CAN, FIP, Ethernet type or another type.

In one embodiment, at least one battery B1 is of the lithium type. The two parallel circuits, recharging and discharging, comprising means K1, K′1 and D1 relating to this battery B1, are comprised in the electronic management entity BMS associated with the battery B1.

In the embodiments described here, the control device DP has the architecture of a computer, as illustrated in FIG. 14. It comprises in particular a processor 7, a random access memory 8, a read-only memory 9, a non-volatile flash memory 10 in a particular embodiment, as well as communication means 11. Such means are known per se and are not described in more detail here.

The read-only memory 9 of the control device DP constitutes a recording medium, readable by the processor 7 and on which is recorded a computer program Prog.

The memory 10 of the control device DP allows recording the variables used for the execution of the steps of a control method, such as the data mes1, mes2, mes3 representing the states of charge of the batteries, the information info-disp representing the activity states of the power supply sources, a value of the countdown timer TIMER used to estimate a state of charge of a battery.

The computer program Prog defines the functional and software modules configured for controlling batteries. These functional modules rely on and/or control the material elements 7-11 of the control device DP previously mentioned.

In the foregoing description, specific details are given to provide a thorough understanding of the examples. However, it will be understood by one of ordinary skill in the art that the examples may be practiced without these specific details. Certain embodiments that are described separately herein can be combined in a single embodiment, and the features described with reference to a given embodiment also can be implemented in multiple embodiments separately or in any suitable subcombination. In some examples, certain structures and techniques may be shown in greater detail than other structures or techniques to further explain the examples.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for controlling recharging and discharging of batteries of a set of batteries, each of the batteries being connected to an electrical circuit connecting a power supply source to a consuming device to form a controllable electrical recharging circuit connecting the battery to the power supply source, and a controllable electrical discharging circuit connecting the battery to the consuming device and performing a diode function to avoid a circulation current between the batteries, the method comprising:
recharging of a first battery of the set, simultaneously with a resting of at least a second battery of the set, the recharging of the first battery being followed by resting of the first battery; or
discharging of a first battery of the set, simultaneously with a resting of at least a second battery of the set, the discharging of the first battery being followed by the resting of the first battery, wherein, in the method:
the recharging of any of the batteries comprises controlling the closing of the electrical recharging circuit corresponding to the battery for recharging the battery by the power supply source;
the discharging of any of the batteries comprises controlling the opening of the electrical recharging circuit and controlling the closing of the electrical discharging circuit corresponding to the battery for discharging the battery for supplying the consuming device; and
the resting of any of the batteries comprises controlling the opening of the electrical recharging and discharging circuits corresponding to the battery in order to rest the battery;
the consuming device being supplied either by the power supply source, or by the discharging of one of the batteries of the set.

2. The method of claim 1, further comprising, for at least one battery of the set, a cyclic sequence including:
at least one recharging followed by one resting; and
at least one discharging followed by one resting.

3. The method of claim 1, also comprising, alternately between at least two of the batteries of the set, a sequence including:
at least one recharging followed by one resting; and
at least one discharging followed by one resting, wherein the durations of the recharging, discharging and resting of the sequence can differ for each of the batteries.

4. The method of claim 1, further comprising monitoring information representing an activity state of the power supply source, wherein:
as long as the state of the power supply source is active, the recharging of the first battery is implemented until a predetermined state of charge, the consuming device being supplied by the power supply source; and
as long as the state of the power supply source is inactive, the discharging of the first battery is implemented until a predetermined state of charge.

5. The method of claim 1, further comprising obtaining an information representing a state of charge of one of the batteries for determining the battery that is recharging or discharging.

6. The method of claim 4, further comprising controlling the power supply source to place it in an active state or in an inactive state, the information representing the activity state of the power supply source being supplied by the control step.

7. The method of claim 6, further comprising determining a duration of activity and a duration of inactivity of the power supply source.

8. The method of claim 6, further comprising determining a duration of activity and a duration of inactivity of the power supply source depending on the information representing the state of charge of the battery.

9. A non-transitory computer readable medium comprising instructions, which when executed by a processor, cause the processor to implement the method of claim 1.

10. A computer comprising a processor and a memory, the memory having stored thereon instructions which when executed by the processor, cause the computer to implement the method of claim 1.

11. A control device for controlling recharging and discharging of batteries of a set of batteries, each of the batteries being configured to be connected to an electrical circuit connecting a power supply source to a consuming device to form a controllable electrical recharging circuit connecting the battery to the power supply source and a controllable electrical discharging circuit connecting the battery to the consuming device and performing a diode function to avoid a circulation current between the batteries, the control device configured to generate at least:
a command for recharging a first battery of the set, simultaneously with the resting of at least one second battery of the set, the recharging of the first battery being followed by resting of the first battery; or
a command for discharging a first battery of the set simultaneously with the resting of at least a second battery of the set, the discharging of the first battery being followed by the resting of the first battery;
the control device configured to generate the recharging and discharging commands such that the consuming device is supplied either by the power supply source or by the discharging of at least one of the batteries of the set;
the recharging of any of the batteries comprising controlling the closing of the electrical recharging circuit corresponding to the battery for recharging the battery from the power supply source;
the discharging of any of the batteries comprising controlling the opening of the electrical recharging circuit and controlling the closing of the electrical discharging circuit corresponding to the battery for discharging the battery to supply the consuming device; and
the resting of any one of the batteries comprising controlling the opening of the electrical recharging and discharging circuits corresponding to the battery for resting the battery.

12. The control device of claim 11, wherein the control device is further configured to:
monitor information representing an activity state of the power supply source; and:
as long as the state of the power supply source is active, control the electrical circuits corresponding to the first battery and the electrical circuits corresponding to the second battery for the recharging of the first battery until a predetermined state of charge; and
as long as the state of the power supply source is inactive, control the electrical circuits corresponding to the first battery and the electrical circuits corresponding to the second battery for the discharging of the first battery until a predetermined state of charge.

13. The control device of claim 11, wherein the control device is further configured to obtain at least one piece of information representing a state of charge of one of the batteries, to determine the battery to be recharged or discharged.

14. The control device according to claim 11 wherein the control device is further configured to control the activity state of the power supply source and obtain information representing the activity state of the power supply source of the control module.

15. A control system for controlling recharging and discharging batteries of a set of the batteries, each of the batteries being configured to be connected to an electrical circuit connecting a power supply source to a consuming device to form a controllable electrical recharging circuit connecting the battery to the power supply source and a controllable electrical discharging circuit connecting the battery to the consuming device, the system including:
the control device of claim 11;
the power supply source; and
the consuming device.

16. The control system of claim 15, wherein the power supply source is one source among an electrical generator, a generator set, a solar panel and a wind turbine.

17. The control system of claim 15, wherein the consuming device is one device among a wireless communication base station and a medical device.
